(19) United States
(12) Patent Application Publication
(10) Pub. No.: US 2007/0202734 A1
(43) Pub. Date: Aug. 30, 2007

(54) Recessed Household Appliance

(75) Inventors: Michael Fugger, Tacherting (DE); Albert Ostermaier, Stein a.d. Traun (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, MUNICH (DE)

(21) Appl. No.: 11/547,023

(22) PCT Filed: Apr. 13, 2005
(86) PCT No.: PCT/EP05/51622

§ 371 Date: Sep. 29, 2006

(30) Foreign Application Priority Data
Apr. 13, 2004 (DE) 10 2004 017 830.5

(51) Int. Cl. H01R 13/62

(52) U.S. Cl. 439/369

(57) ABSTRACT

A recessed household appliance comprising an appliance unit, a receiving device provided with a recess in which the appliance unit is arranged during the operation thereof and from which the appliance unit can also be removed, and an electrical connection socket which is arranged on the receiving device and is used to connect an electric cable that is arranged on the appliance unit and can be automatically shortened.

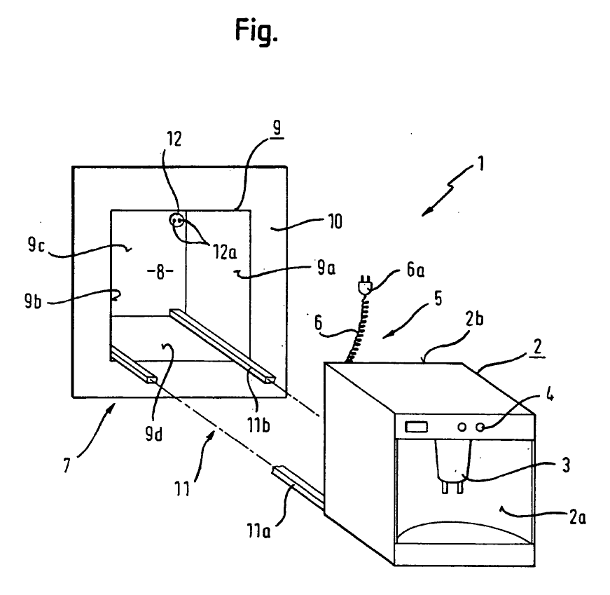

The invention relates to a recessed household appliance, preferably a built-in coffee machine.

A household appliance of this type is known from WO 01/72 188 A1. In a first exemplary embodiment of this document, the appliance unit defined with the aid of a receiving device which comprises a mounting frame provided with a mounting cavity, is built into a suitable structure, that is, for example, a kitchen furniture, a wall niche or similar. At its left lower front area when viewed by the observer, the mounting frame has a connection box which contains a connection socket for a plug of a power cord connected to the appliance unit. For mounting the appliance unit inside the receiving device, the appliance unit must first be placed on a storage surface which is located as close as possible and at the same height as the mounting frame. Alternatively, the appliance unit must be held by a second person while the first person makes the electrical connection, i.e. puts the plug in the receiving socket. The appliance unit must then be inserted by the operator into the mounting frame where care must be taken to ensure that the electrical connection is not separated again. The risk of an unintentional separation of the electrical connection is increased by the provision of a connection box which certainly facilitates making the electrical connection, particularly if the appliance unit can be held and not put down, but also facilitates an unintentional separation if, for example, the power cord becomes jammed between the base of the appliance unit and the mounting frame and is pulled during insertion of the appliance unit. Dismounting the appliance unit is equally inconvenient since the appliance unit again needs to be put down here before the electrical connection can be separated. It should be noted that in-wall coffee makers themselves can have a relatively high weight, 45 kg for example. It is very difficult to hold such an appliance with only one hand in order to separate the electrical connection with the other hand.

It is further described that the appliance unit can be arranged on a type of drawer, the electrical connection being embodied as a direct plug connection which makes an electrical connection as soon as the drawer has been displaced completely into the in-wall position. In this case, the mounting can certainly be accomplished by a single person but the correct electrical connection is extremely difficult. Drawers of this type, in particular if they carry very heavy appliance units, never run on an exact predefined path. Even deviations by a fraction of a millimeter, for example as a result of vibrations of the drawer or as a result of a slightly inaccurate positioning of the appliance unit on the drawer, can have the result that the plug contacts never enter into the sockets but strike adjacently and are bent when a fairly large force is applied so that the electrical connection cannot be made successfully.

It is thus the object of the invention to provide a recessed household appliance which can be mounted easily and securely in a constructively simple manner.

The object is achieved by a recessed household appliance comprising an appliance unit, a receiving device comprising a mounting cavity in which the appliance unit is arranged during its operation as intended and from which said appliance unit can be removed, and an electrical connection socket arranged on the receiving device for connection of a power cord arranged on the appliance unit, characterized in that the power cord can be automatically shortened.

The recessed household appliance according to the invention can be mounted easily and securely by a single person and the electrical connection can be made quickly and securely without needing to take particular care.

According to one variant of the recessed household appliance according to the invention, the appliance unit is arranged on an extension device and can be moved into and out of the mounting cavity by means of the extension device. The combination of an extension device on which the appliance unit is arranged and can be moved and the power cord which can be automatically lengthened and shortened ensures, on the one hand, that the electrical connection can be conveniently made when the appliance unit is located still relatively far outside the mounting cavity so that the mounting cavity is freely accessible. On the other hand, this prevents any excess length of the power cord from becoming jammed somewhere during insertion of the appliance unit into the mounting cavity, exerting a pull on the power cord which could result in separation of the electrical connection or prevent the correct positioning of the appliance unit.

Advantageous further developments of the invention can be deduced from the dependent claims.

The power cord is preferably a spiral cord such as is available commercially and is used, for example, for fairly small electric tools or telephone handsets.

The connecting socket is preferably arranged in the mounting cavity and the cord with plug is arranged on the appliance unit since many recessed household appliances are already provided with a power cord with plug during series production so that the construction of the household appliance need not be modified. In this case, the connecting socket is arranged in particular in the upper, lower or rear area of the mounting cavity. The recessed household appliance according to the invention is in particular a built-in coffee machine.

An exemplary embodiment of a recessed household appliance according to the invention in the form of a built-in coffee machine is explained as an example hereinafter with reference to the single schematic drawing.

The Figure shows a perspective and schematic view of a recessed household appliance 1 comprising an appliance unit 2 which in the exemplary embodiment shown is a built-in coffee machine. The built-in coffee machine can be one of the usual automatic domestic machines for the automatic or predominantly automatic preparation of different coffee drinks, hot water, and milk froth.

A front side 2a which faces the operator in the built-in state and a rear side 2b is defined on the appliance unit 2. Provided at or in the vicinity of the front side 2a is the usual dispensing device 3 for drinks, and control elements 4 while the rear side 2b bears components of the electrical connection 5 among others. The electrical connection 5 contains a power cord 6 with a plug 6a which, in the exemplary embodiment shown is arranged on the appliance unit 2. The power cord 6 is arranged at the usual position for the particular household appliance, preferably in the lower area of the rear wall and near a corner.

The household appliance 1 as a built-in appliance further contains a receiving device designated overall as 7. The receiving device 7 defines a cavity 8 which is shaped and dimensioned such that the appliance unit 1 with the power cord 6 can be conveniently accommodated. The receiving device 7 can, for example, contain a mounting housing 9 with side walls 9a and 9b, a rear wall 9c and a base surface 9d. However, the mounting housing 9 need not necessarily consist of closed walls but can comprise any suitable structure which on the one hand, is the size of the cavity 8 and can receive the appliance unit 1.

In the exemplary embodiment shown, the mounting housing 9 is recessed in a front panel 10, where the front panel 10 can either be part of furniture or a wall cavity or similar.

The receiving device 7 furthermore contains an extension device 11 which, in the exemplary embodiment shown, contains two extension rails 11a and 11b which can be embodied similarly to commercially available telescopic extension units such as those used, for example, for drawers or similar. The extension device 11 can, however, also be an extendable tray or similar which runs in guides which are secured against tipping underneath or above the base 9d.

A connection socket 12 of the electrical connection 5 is furthermore accommodated in the interior of the mounting cavity 8. The connection socket 12 can be any usual plug socket or similar into which the plug 6a fits. The connection socket 12 can be connected to an external power supply by means of a fixedly installed lead or via a further cord.

The connection socket 12 is accommodated in the cavity 8. The preferred point of application of the connection socket 12 lies in the rear right upper area of the cavity 8 so that an operator who is right-handed, can easily insert the plug 6a into the connection socket 12 without any problems. In the exemplary embodiment shown, the connection socket 12 is fastened to the rear wall 9c and specifically in the upper right corner where the rear wall 9c impinges on the right side wall 9a when viewed by the observer and the roof, not shown, opposite to the base 9d. The electrical connection can be made most simply at this point since the observer has a direct view of the contacts 12a of the connection socket 12 and sees precisely where the plug 6a is to be inserted even if it is dark in the cavity 8. A possible application site of the connection socket 12 however would be in any other position on the rear wall 9c, on the side wall 9a in the vicinity of the rear wall 9c or on the roof, likewise in the vicinity of the rear wall 9c.

For installation of the household appliance 1 according to the invention, the appliance unit 2 is arranged on the extension device 11 in the correct position and preferably fastened. The plug 6a is then gripped and the power cord 6 is lengthened by pulling out its spiral turns until the plug 6a can be inserted in the socket 12. Optionally, the appliance unit 2 can already be displaced to some extent in the direction of the cavity 8. The appliance unit 2 is then pushed completely into the cavity 8, the power cord automatically contracting again to its original substantially smaller length and thus being accommodated in a space-saving manner between the rear wall 9c and the rear side 2b of the appliance unit 2 without the risk of parts of the cord becoming entangled in the extension device 11 or becoming jammed between the appliance unit 2 and the walls of the cavity 8. The appliance unit 2 can then be fixed in the cavity 8, for example, by means of a panel placed at the front if this is desired and necessary.

As a modification of the exemplary embodiments which have been described and shown, the power cord can also be embodied as smooth cord and be provided with an automatic cord winding means such as is used for vacuum cleaners, for example, where the cord can be lengthened by pulling and then automatically winds up again after releasing a stopping means, for example, with the aid of a spring and thus is shortened again. Instead of the coffee machine shown, other household appliances can also be built in in the manner described.

1-6. (canceled)

7. A recessed household appliance comprising:
an appliance unit;
a receiving device comprising a mounting cavity in which the appliance unit is arranged during its operation as intended and from which said appliance unit can be removed; and
an electrical connection socket arranged on the receiving device for connection of a power cord arranged on the appliance unit, wherein the power cord can be automatically shortened.

8. The recessed household appliance according to the claim 7, further comprising an extension device movably supporting the appliance unit, the appliance unit being movable into and out of the mounting cavity on the extension device.

9. The recessed household appliance according to the claim 7, wherein the power cord includes a spiral cord.

10. The recessed household appliance according to claim 7, wherein the connection socket is arranged in at least one of an upper, lower and rear area of the mounting cavity.

11. The recessed household appliance according to claim 7, wherein the mounting cavity comprises a rear wall and the connection socket is arranged on the rear wall.

12. The recessed household appliance according to claim 7, wherein the household appliance includes a built-in coffee machine.
